(19) United States
(12) Patent Application Publication
(10) Pub. No.: US 2004/0040988 A1
(43) Pub. Date: Mar. 4, 2004

(54) High pressure ball and valve seat

(76) Inventors: Kevin L. Alexander, Brownsburg, IN (US); John Anthony Rogers, Broadstone (GB)

Correspondence Address: BARNES & THORNBURG, 11 SOUTH MERIDIAN, INDIANAPOLIS, IN, 46204

(21) Appl. No.: 10/232,456

(22) Filed: Aug. 30, 2002

(51) Int. Cl. B67D 3/00

(52) U.S. Cl. 222/530

(57) ABSTRACT

A system for dispensing coating material includes a source of coating material to be dispensed and a device for dispensing the coating material. The coating material is provided from the source under pressure to the device. The device includes a body having a passageway therethrough. A valve includes a valve seat provided in the passageway and a valve member for engaging the valve seat to close the valve and moving away from the valve seat to open the valve. In one embodiment, the valve seat and valve member are so dimensioned that when the valve member is against the valve seat, a portion of the valve member facing the valve seat is exposed to the pressurized coating material. In another, the valve seat, a downstream-most portion of the valve member, and a shoulder on the valve member are so dimensioned that the shoulder isolates the downstream-most portion from the liquid under pressure when the downstream-most portion is against the valve seat. In yet another, the valve seat and downstream-most portion are so dimensioned that when the downstream-most portion is against the valve seat, the downstream-most portion is not exposed to the pressurized coating material.

### FIELD OF THE INVENTION

This invention relates to improvements in valves for controlling the flow of pressurized fluids. It is disclosed in the context of valves for controlling the flow of coating materials through coating material dispensers. However, it is believed to have other applications as well.

### BACKGROUND OF THE INVENTION

Handheld coating material dispensing devices of various types are well-known. There are, for example, the guns illustrated and described in U.S. Pat. Nos.: 3,169,882; 4,002,777; and, 4,285,446. There are also the Ransburg model REA 3, REA 4, REA 70, REA 90, REM and M-90 guns, all available from ITW Ransburg, 320 Phillips Avenue, Toledo, Ohio, 43612-1493. No representation is intended by this listing that a thorough search of all material prior art has been conducted, or that no better art than that listed is available. Nor should any such representation be inferred.

Many currently available hydraulic atomizers require considerable trigger pull force to open the valve controlled by the trigger when the liquid to be atomized is at relatively high fluid pressure, for example, 1500 p.s.i.g. (about 10.34×10⁶ N/m²) or more. Trigger pull forces with currently available hydraulic atomizers are also highly fluid pressure sensitive. As the fluid pressure increases, trigger pull force increases linearly. The valves tend to operate only in a full-on/full off mode, providing no opportunity for the operator to feather the valve open or closed.

### DISCLOSURE OF THE INVENTION

According to a first aspect of the invention, a device for dispensing a liquid from a source of the liquid under pressure includes a body having, a passageway therethrough. A valve includes a valve seat provided in the passageway and a valve member for engaging the valve seat to close the valve and moving away from the valve seat to open the valve. The valve seat and valve member are so dimensioned that when the valve member is against the valve seat, a portion of the valve member facing the valve seat is exposed to the liquid under pressure.

Illustratively according to this aspect of the invention, the valve member includes a spherically shaped portion. The portion of the valve member facing the valve seat includes the spherically shaped portion. The valve seat and spherically shaped portion are so dimensioned that when the spherically shaped portion is against the valve seat, a portion of the spherically shaped portion facing the valve seat is exposed to the liquid under pressure.

Further illustratively according to this aspect of the invention, the valve member includes a surface further upstream from the valve seat than the spherically shaped portion in the direction of flow of the liquid through the device. The surface generally faces the valve seat. The surface is exposed to the liquid under pressure.

According to a second aspect of the invention, a device for dispensing a liquid from a source of the liquid under pressure includes a body having a passageway therethrough. A valve includes a valve seat provided in the passageway and a valve member for engaging the valve seat to close the valve and moving away from the valve seat to open the valve. The valve member further includes a shoulder adjacent and upstream from a downstream-most portion of the valve member in the direction of flow of the liquid through the device. The valve seat, valve member and shoulder are so dimensioned that the shoulder isolates the downstream-most portion of the valve member from the liquid under pressure when the valve member is against the valve seat.

Illustratively according to this aspect of the invention, the downstream-most portion includes a spherically shaped portion. The valve seat, spherically shaped portion and shoulder are so dimensioned that the shoulder isolates the spherically shaped portion from the liquid under pressure when the spherically shaped portion is against the valve seat.

According to a third aspect of the invention, a device for dispensing a liquid from a source of the liquid under pressure includes a body having a passageway therethrough. A valve includes a valve seat provided in the passageway and a valve member including a downstream-most portion for engaging the valve seat to close the valve and moving away from the valve seat to open the valve. The valve seat and downstream-most portion are so dimensioned that when the downstream-most portion is against the valve seat, the downstream-most portion is not exposed to the pressure of the liquid.

Illustratively according to this aspect of the invention, the downstream-most portion includes a spherically shaped portion. The valve seat and spherically shaped portion are so dimensioned that when the spherically shaped portion is against the valve seat, the spherically shaped portion is not exposed to the pressure of the liquid.

Illustratively according to these aspects of the invention, the passageway includes a shoulder adjacent the valve seat. The body further includes a reducer section downstream in the flow of the liquid through the device.

According to a fourth aspect of the invention, a system for dispensing coating material includes a source of coating material to be dispensed and a device for dispensing the coating material. The coating material is provided from the source under pressure to the device. The device includes a body having a passageway therethrough. A valve includes a valve seat provided in the passageway and a valve member for engaging the valve seat to close the valve and moving away from the valve seat to open the valve. The valve seat and valve member are so dimensioned that when the valve member is against the valve seat, a portion of the valve member facing the valve seat is exposed to the pressurized coating material.

Illustratively according to this aspect of the invention, the valve member includes a spherically shaped portion. The portion of the valve member facing the valve seat includes the spherically shaped portion. The valve seat and spherically shaped portion are so dimensioned that when the spherically shaped portion is against the valve seat, a portion of the spherically shaped portion facing the valve seat is exposed to the liquid under pressure.

Illustratively according to this aspect of the invention, the valve member further includes a surface further upstream from the valve seat than the spherically shaped portion in the direction of flow of the liquid. The surface generally faces the valve seat. The surface is exposed to the pressurized coating material.

According to a fifth aspect of the invention, a system for dispensing coating material includes a source of coating material to be dispensed and a device for dispensing the coating material. The coating material is provided from the source under pressure to the device. The device includes a body having a passageway therethrough. A valve includes a valve seat provided in the passageway and a valve member including a downstream-most portion for engaging the valve seat to close the valve and moving away from the valve seat to open the valve. The valve member further includes a shoulder adjacent and upstream from the downstream-most portion in the direction of flow of the liquid through the device. The valve seat, downstream-most portion and shoulder are so dimensioned that the shoulder isolates the downstream-most portion from the liquid under pressure when the downstream-most portion is against the valve seat.

Illustratively according to this aspect of the invention, the downstream-most portion includes a spherically shaped portion. The valve seat, spherically shaped portion and shoulder are so dimensioned that the shoulder isolates the spherically shaped portion from the liquid under pressure when the spherically shaped portion is against the valve seat.

According to a sixth aspect of the invention, a system for dispensing coating material includes a source of coating material to be dispensed and a device for dispensing the coating material. The coating material is provided from the source under pressure to the device. The device includes a body having a passageway therethrough. A valve includes a valve seat provided in the passageway and a valve member including a downstream-most portion for engaging the valve seat to close the valve and moving away from the valve seat to open the valve. The valve seat and downstream-most portion are so dimensioned that when the downstream-most portion is against the valve seat, the downstream-most portion is not exposed to the pressurized coating material.

Illustratively according to this aspect of the invention, the downstream-most portion includes a spherically shaped portion. The valve seat and spherically shaped portion are so dimensioned that when the spherically shaped portion is against the valve seat, the spherically shaped portion is not exposed to the pressurized coating material.

Illustratively according to the fourth, fifth and sixth aspects of the invention, the passageway includes a shoulder adjacent the valve seat. The body further includes a reducer section downstream in the flow of the coating material through the device.

### BRIEF DESCRIPTION OF THE DRAWINGS

The invention may best be understood by referring to the following description and accompanying drawings which illustrate the invention. In the drawings:

FIG. 1 illustrates a side elevational view of an atomizer of a type which is capable of incorporating the invention, with other components of a system incorporating the atomizer illustrated diagrammatically;

FIG. 2 illustrates a fragmentary longitudinal sectional side elevational view of an atomizer including a valve constructed according to the invention;

FIG. 3 illustrates an enlarged front elevational view of a detail of FIG. 2, taken generally along section lines 3-3 of FIG. 2;

FIG. 4 illustrates an enlarged longitudinal sectional side elevational view of the detail of FIG. 3, taken generally along section lines 4-4 of FIG. 3;

FIG. 5 illustrates an enlarged longitudinal sectional side elevational view of a detail of FIGS. 2-4;

FIG. 6 illustrates an enlarged longitudinal sectional side elevational view of a detail of FIGS. 2-4;

FIG. 7 illustrates a fragmentary longitudinal sectional side elevational view of an atomizer including a valve constructed according to the invention;

FIG. 8 illustrates an enlarged front elevational view of a detail of FIG. 7, taken generally along section lines 8-8 of FIG. 7;

FIG. 9 illustrates an enlarged longitudinal sectional side elevational view of the detail of FIG. 8, taken generally along section lines 9-9 of FIG. 8;

FIG. 10 illustrates an enlarged longitudinal sectional side elevational view of a detail of FIG. 7;

FIG. 11 illustrates an enlarged longitudinal sectional side elevational view of a detail of FIGS. 7-9;

FIG. 12 illustrates an enlarged longitudinal sectional side elevational view of a detail of FIGS. 7-9;

FIG. 13 illustrates a fragmentary longitudinal sectional side elevational view of an atomizer including a valve constructed according to the invention;

FIG. 14 illustrates an enlarged front elevational view of a detail of FIG. 13, taken generally along section lines 14-14 of FIG. 13;

FIG. 15 illustrates an enlarged longitudinal sectional side elevational view of the detail of FIG. 14, taken generally along section lines 15-15 of FIG. 14;

FIG. 16 illustrates an enlarged longitudinal sectional side elevational view of a detail of FIGS. 13-15;

FIG. 17 illustrates an enlarged longitudinal sectional side elevational view of a detail of FIGS. 13-15;

FIG. 18 illustrates an enlarged longitudinal sectional side elevational view of a detail I of FIG. 13; and,

FIG. 19 illustrates a detail of FIG. 18.

### DETAILED DESCRIPTIONS OF THE ILLUSTRATIVE EMBODIMENTS

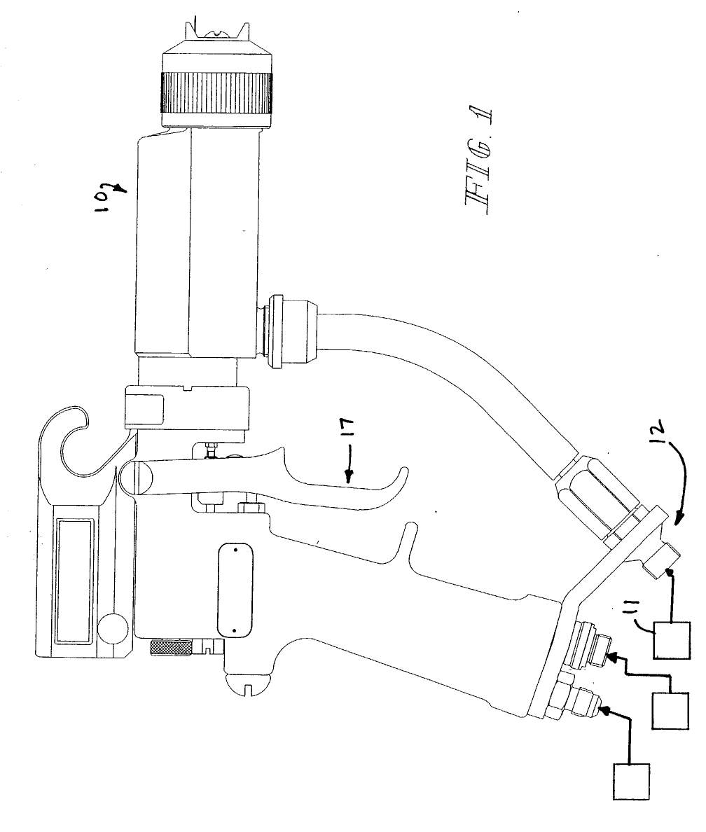

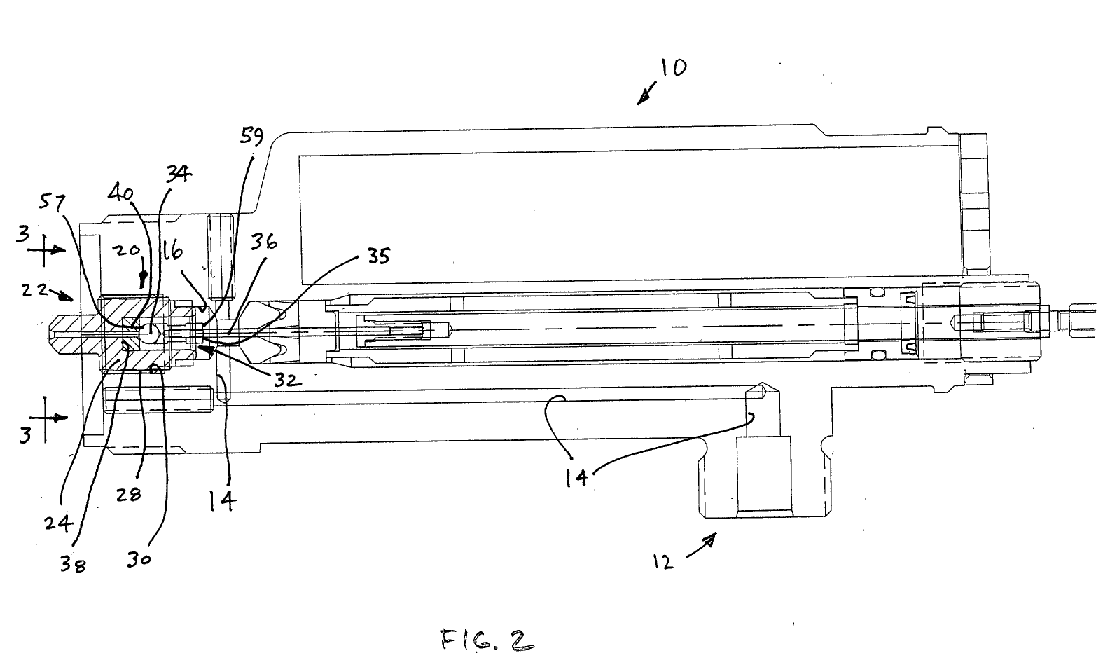

The valves of the present invention are intended to permit the control of the dispensing of liquids, for example, coating materials and the like, which are supplied at, for example, from about 1500 p.s.i.g. (about 10.34×10⁶ N/m²) to about 4000 p.s.i.g. (about 2.76×10⁷ N/m²). The valves of the present invention are intended to reduce the static force required to open the valve and maintain the valve in a less than fully opened orientation. Referring to FIG. 1, in a typical implementation, the valve is provided in a dispensing device (hereinafter sometimes “gun”) 10. Gun 10 illustratively is of the general type of the Ransburg model REM and M-90 guns, available from ITW Ransburg, 320 Phillips Avenue, Toledo, Ohio, 43612-1493. The liquid is supplied from a source 11 to an input port 12 of the gun 10, and is supplied through a passageway 14 (FIGS. 2, 7 and 13) in the gun 10 to a gallery 16 upstream from the valve in the flow path of the liquid being dispensed. The liquid is dispensed from the gallery 16 under the control of the valve to the nozzle of the gun 10 to be atomized and dispensed. For example, a trigger 17 held by a gun 10 operator, controls the position of the valve.

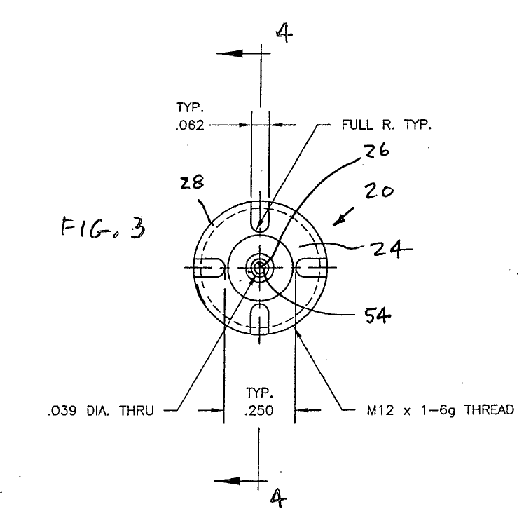

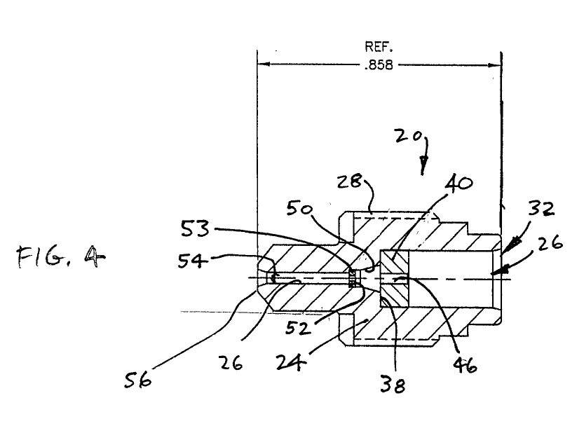

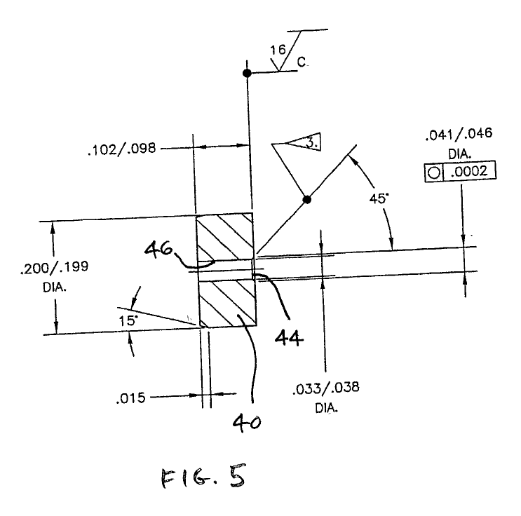

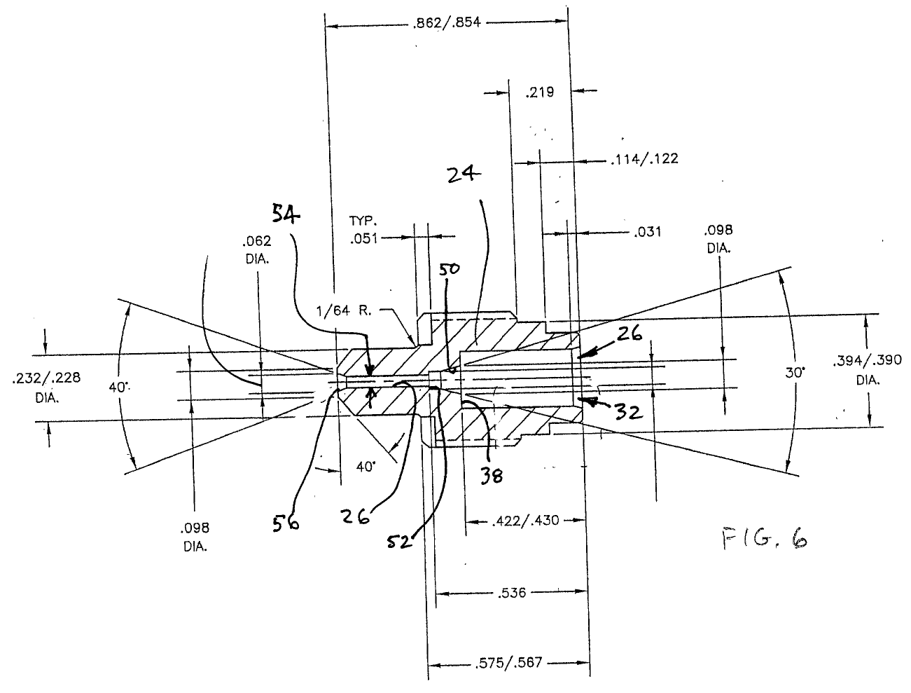

A first embodiment of the valve is illustrated in FIGS. 2-6. A screw-in valve assembly 20 for a nozzle 22 includes a nozzle seal valve screw body 24 having a central passageway 26 therethrough and threads 28 for engaging complementary threads 30 on the nozzle 22 body. The rearward end 32 of the central passageway 26 has a larger diameter accommodating the forward, spherically shaped end 34 of the valve needle 36. The rearward end 32 of the passageway includes a shoulder 38 against which a valve seat 40 rests when the valve seat 40 is inserted into the larger diameter rearward end 32 of the passageway 26 from the rear. The valve seat 40 includes a slight rearwardly flaring chamfer 44 (FIG. 5) at the edge of the passageway 46 therethrough. Forward of the shoulder 38 is a frustoconically shaped reducer section 50 of the nozzle seal valve screw body 24. At the forward end of reducer section 50 is another shoulder 52. A flow restrictor 53 (FIG. 4) having a central passageway coaxial with passageway 26 is inserted into passageway 26 against shoulder 52. Forward of the shoulder 52, the passageway 26 assumes a diameter 54 which remains constant substantially to the forward end 56 of nozzle seal valve screw body 24. The chamfer 44 is so configured that when the ball 34 is seated, a front portion of the ball 34 is exposed to fluid pressure. In this design, the front spherical surface 57 of the ball 34 and a rearward part 59 of the needle are both exposed to fluid pressure.

In an illustrative device constructed according to this embodiment of the invention, the rearward end 32 of central passageway 26 has a diameter of 0.197″ (about 5 mm). Valve seat 40 is cemented into rearward end 32 against shoulder 38 using, for example, Loctite 7969-03 cement. The forward, spherically shaped end 34 of needle 36 has a diameter of 3 mm. Valve needle 36 illustratively is an ITW Ransburg Electrostatic Systems part number 73350-00 needle valve. Rearwardly flaring chamfer 44 makes an angle of 45″ to the axis of passageway 26, flaring outward from a passageway 46 diameter of 0.033″ (about 0.83 mm) to a diameter of 0.038″ (about 0.97 mm). The larger base of frustoconically shaped reducer section 50 has a diameter of 0.098″ (about 2.49 mm). The angle the sidewall of frustoconically shaped reducer section 50 makes with the axis of passageway 26 is 15°. The smaller base of reducer section 50, at shoulder 52, has a diameter illustratively of 0.060″ (about 1.52 mm) or 0.076″ (about 1.93 mm). Diameter 54 illustratively is 0.039″ (about 0.99 mm). Flow restrictor 53 has an orifice diameter between 0.0101″ (about 0.26 mm) and 0.0221″ (about 0.56 mm). Flow restrictor 53 is cemented into passageway 26 against shoulder 52 using, for example, Loctite 7969-03 cement. Flow restrictor 53 illustratively is an ITW Ransburg Electrostatic Systems part number 76763-01, -02, -03, -04, -05, -06 or -07 flow restrictor.

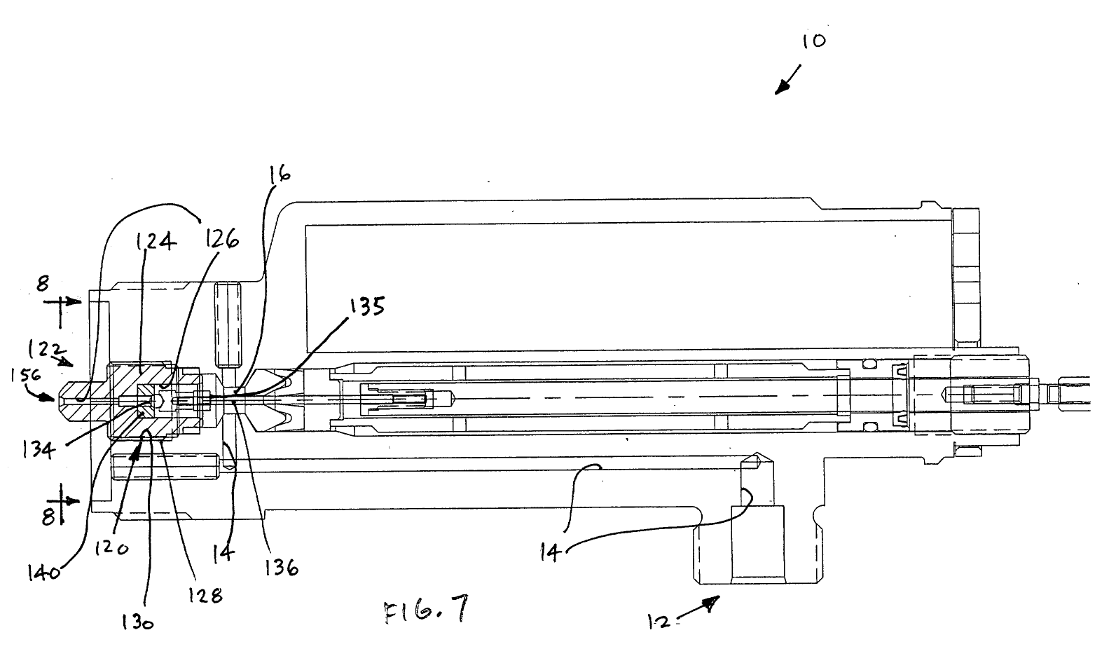

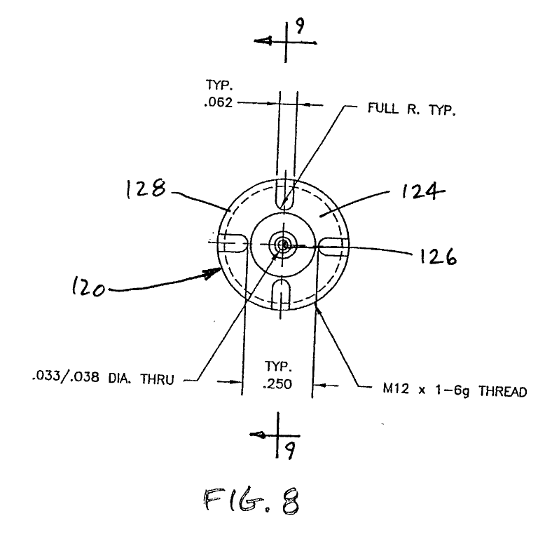

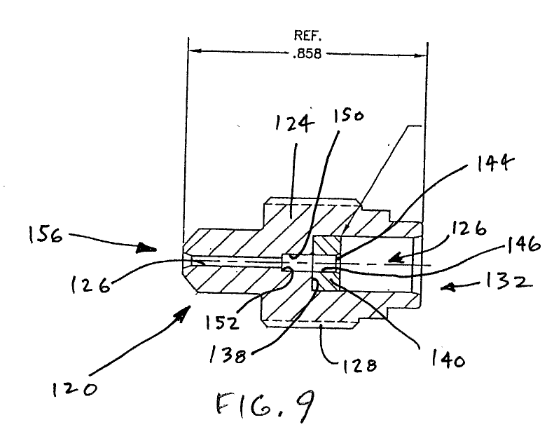

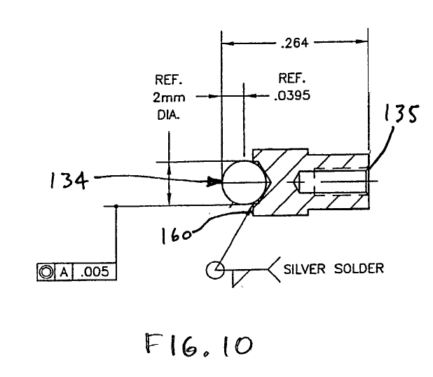

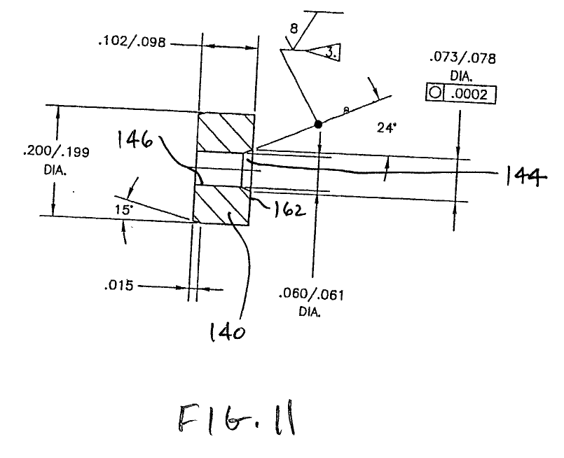

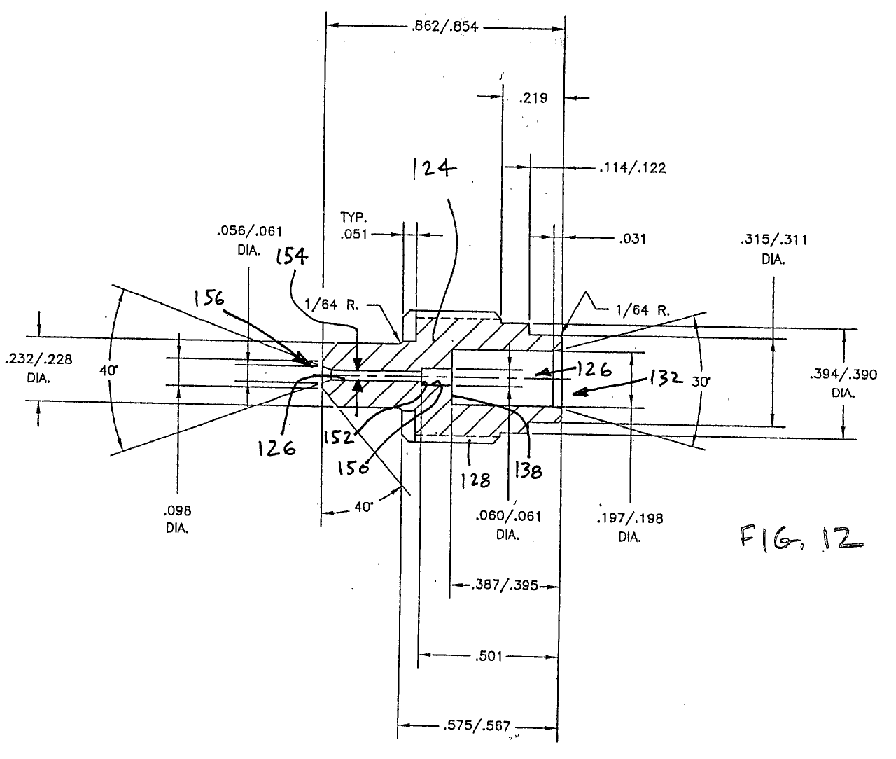

A second embodiment of the valve is illustrated in FIGS. 7-12. A screw-in valve assembly 120 for a nozzle 122 includes a nozzle seal valve screw body 124 having a central passageway 126 therethrough and threads 128 for engaging complementary threads 130 on the nozzle 122 body. The rearward end 132 of the central passageway 126 has a larger diameter accommodating the forward, spherically shaped end 134 of the valve needle 136. The rearward end 132 of the passageway includes a shoulder 138 (FIGS. 9 and 12) against which a valve seat 140 (FIGS. 7, 9 and 11) rests when the valve seat 140 is inserted into the larger diameter rearward end 132 of the passageway 126 from the rear. The valve seat 140 includes a rearwardly flaring chamfer 144 at the edge of the passageway 146 therethrough. Forward of the shoulder 138 is a reducer section 150 of the nozzle seal valve screw body 124. At the forward end of reducer section 150 is another shoulder 152. Beyond shoulder 152, the passageway 126 assumes a diameter 154 which remains constant substantially to the forward end 156 of nozzle seal valve screw body 124. The needle 136 is fabricated using a ball 134 that leaves a shoulder 160 (FIG. 10) at the front of the needle 136 body and the gauge diameter of the valve seat 140 is substantially the ball 134 diameter. This permits the forwardmost portion of the ball 134 to sit substantially completely inside the valve seat taper 144. In this design, a shoulder 162 of the valve seat 140 and the shoulder 160 at the front of the needle 136 body are exposed to the fluid pressure, instead of the spherical surface of the ball 134.

In an illustrative device constructed according to this embodiment of the invention, the rearward end 132 of central passageway 126 has a diameter of 0.197″ (about 5 mm). Valve seat 140 is cemented into rearward end 132 against shoulder 138 using, for example, Loctite 7969-03 cement. The forward, spherically shaped end 134 of needle 136 has a diameter of 2 mm. Rearwardly flaring chamfer 144 makes an angle of 24″ to the axis of passageway 126, flaring outward from a passageway 146 diameter of 0.060″ (about 1.52 mm) to a diameter of 0.062″ (about 1.57 mm). The diameter of section 150 is 0.060″ (about 1.52 mm). Diameter 154 illustratively is 0.033″ (about 0.83 mm) to about 0.038″ (about 0.97 mm).

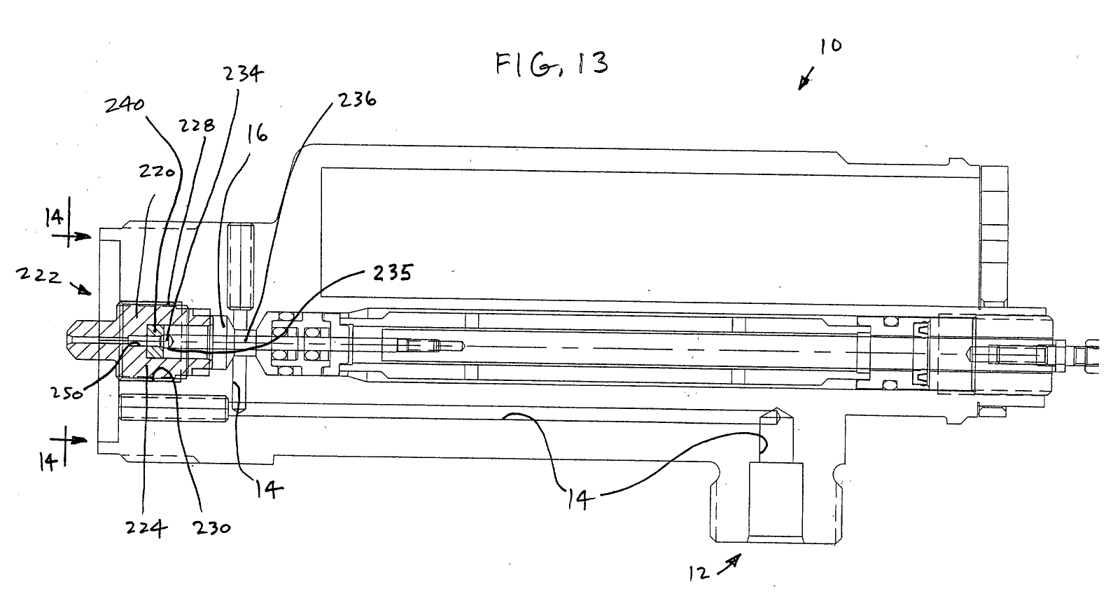

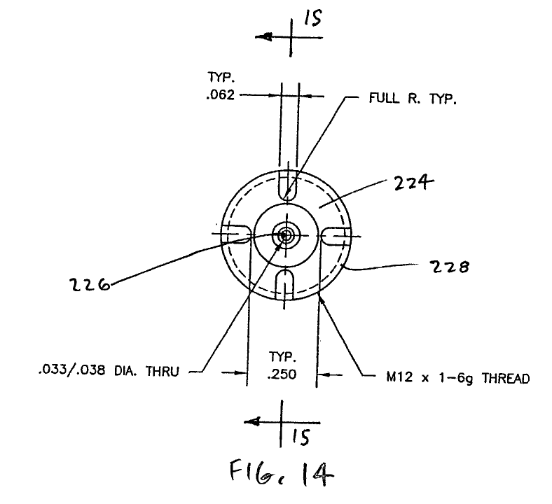

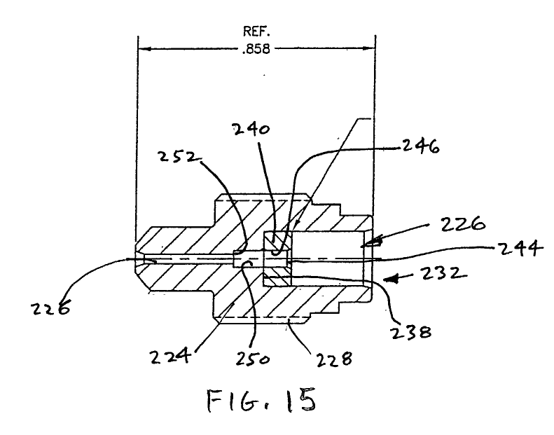

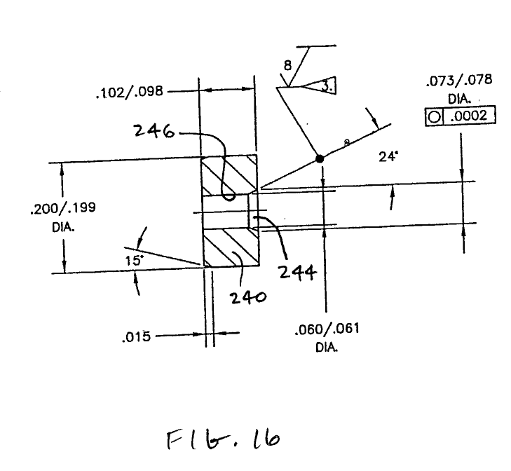

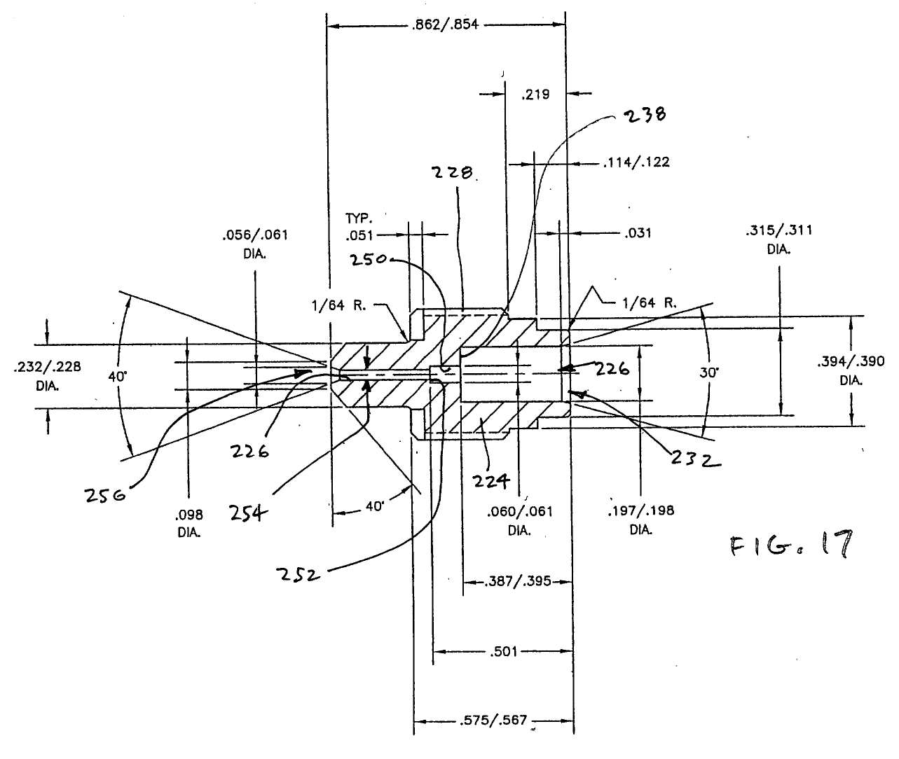

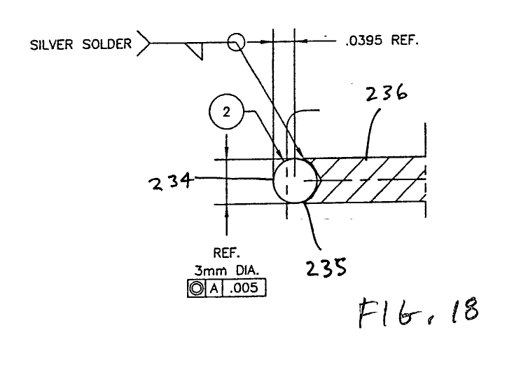

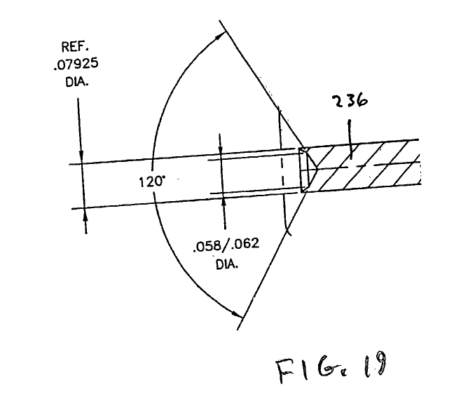

A third embodiment of the valve is illustrated in FIGS. 13-19. A screw-in valve assembly 220 for a nozzle 222 includes a nozzle seal valve screw body 224 having a central passageway 226 therethrough and threads 228 for engaging complementary threads 230 on the nozzle 222 body. The rearward end 232 of the central passageway 226 has a larger diameter accommodating the forward, spherically shaped end 234 (FIGS. 13 and 18) of the valve needle 236. The rearward end 232 of the passageway includes a shoulder 238 (FIGS. 15 and 17) against which a valve seat 240 (FIGS. 13, 15 and 16) rests when the valve seat 240 is inserted into the larger diameter rearward end 232 of the passageway 226 from the rear. The valve seat 240 includes a rearwardly flaring chamfer 244 (FIGS. 15 and 16) at the edge of the passageway 246 therethrough. Forward of the shoulder 238 is a reducer section 250 of the nozzle seal valve screw body 224. At the forward end of reducer section 250 is another shoulder 252 (FIGS. 15 and 17). Beyond shoulder 252, the passageway 226 assumes a diameter 254 (FIG. 17) which remains constant substantially to the forward end 256 of nozzle seal valve screw body 224. The needle 236 is fabricated using a ball 234 that has substantially the same diameter as the needle 236 body (FIGS. 18 and 19) and the gauge diameter of the valve seat 240 is substantially the ball 234 diameter. This permits the forward portion of ball 234 to sit substantially completely inside the valve seat 240 taper 244 with the surface of ball 234 substantially unexposed to static pressure inside the fluid chamber 16 which otherwise would tend to hold valve 234, 236, 240 open or closed.

In an illustrative device constructed according to this embodiment of the invention, the rearward end 232 of central passageway 226 has a diameter of 0.197″ (about 5 mm). Valve seat 240 is cemented into rearward end 232 against shoulder 238 using, for example, Loctite 7969-03 cement. The forward, spherically shaped end 234 of needle 236 has a diameter of 2 mm. Rearwardly flaring chamfer 244 makes an angle of 24″ to the axis of passageway 226, flaring outward from a passageway 246 diameter of 0.060″ (about 1.52 mm) to a diameter of 0.073″ (about 1.85 mm) or 0.078″ (about 1.98 mm). The diameter of section 250 is 0.060″ (about 1.52 mm). Diameter 254 illustratively is 0.033″ (about 0.83 mm) to about 0.038″ (about 0.97 mm).

At a fluid pressure of 2500 p.s.i.g. (about 1.72×10⁷ N/m²), this results in a reduced trigger pull force from 16 pounds (about 71 N) to 8 pounds (about 35.6 N). The trigger pull force that is required is more consistent across a broad range of fluid pressures. The reduction in force promotes feathering of the flow of coating material to the nozzle 22, 122, 222 to other flow rates besides full on and off.

Trigger operation in prior art ball and valve seat designs had somewhat of a “digital” feel. This resulted, it is believed, from the relatively considerably greater force required to crack the valve open and the relatively considerably smaller force required to hold the valve open. This rendered it difficult for the operator to adjust the force between these two extremes, and therefore to provide the desired control of the flow rate of material through h the valve. In order to provide the operator greater control of the material flow rate, the present invention seeks to bring the valve opening force and force required to maintain the valve in an open orientation closer together. The invention seeks to achieve this objective by, among other things, selection of the dimensions of the valve seat 40, 140, 240 contact diameter, that is the diameter of the circle of contact between the valve ball 34, 134, 234 and the valve seat 40, 140, 240, respectively, and the diameter of the valve needle 36, 136, 236 at its junction 35, 135, 235 with the valve head where the ball 34, 134, 234 is mounted. In the illustrated embodiments, these dimensions are brought closer together than in the prior art, reducing the transition in force from the force required to crack the valve open to the force required to hold the valve open. The force transition is reduced from the prior art's relatively considerably greater force required to crack the valve open and the relatively considerably smaller force required to hold the valve open to a relatively only somewhat greater force required to crack the valve open and a relatively only somewhat smaller force required to hold the valve open.

What is claimed is:

1. A device for dispensing a liquid from a source of the liquid under pressure, the device including a body having a passageway therethrough, a valve including a valve seat provided in the passageway and a valve member for engaging the valve seat to close the valve and moving away from the valve seat to open the valve, the valve seat and valve member being so dimensioned that when the valve member is against the valve seat, a portion of the valve member facing the valve seat is exposed to the liquid under pressure.

2. The device of claim 1 wherein the valve member includes a spherically shaped portion, the portion of the valve member facing the valve seat including the spherically shaped portion, the valve seat and spherically shaped portion being so dimensioned that when the spherically shaped portion is against the valve seat, a portion of the spherically shaped portion facing the valve seat is exposed to the liquid under pressure.

3. The device of claim 2 wherein the valve member further includes a surface further upstream from the valve seat than the spherically shaped portion in the direction of flow of the liquid through the device, the surface generally facing the valve seat, the surface being exposed to the liquid under pressure.

4. The device of claim 1 wherein the passageway includes a shoulder adjacent the valve seat and the body further includes a reducer section downstream in the flow of the liquid through the device.

5. A device for dispensing a liquid from a source of the liquid under pressure, the device including a body having a passageway therethrough, a valve including a valve seat provided in the passageway and a valve member for engaging the valve seat to close the valve and moving away from the valve seat to open the valve, the valve member further including a shoulder adjacent and upstream from a downstream-most portion of the valve member in the direction of flow of the liquid through the device, the valve seat, valve member and shoulder being so dimensioned that the shoulder isolates the downstream-most portion of the valve member from the liquid under pressure when the valve member is against the valve seat.

6. The device of claim 5 wherein the downstream-most portion includes a spherically shaped portion, the valve seat, spherically shaped portion and shoulder being so dimensioned that the shoulder isolates the spherically shaped portion from the liquid under pressure when the spherically shaped portion is against the valve seat.

7. The device of claim 5 wherein the passageway includes a shoulder adjacent the valve seat, and the body further includes a reducer section downstream in the flow of liquid through the device.

8. A device for dispensing a liquid from a source of the liquid under pressure, the device including a body having a passageway therethrough, a valve including a valve seat provided in the passageway and a valve member including a downstream-most portion for engaging the valve seat to close the valve and moving away from the valve seat to open the valve, the valve seat and downstream-most portion being so dimensioned that when the downstream-most portion is against the valve seat, the downstream-most portion is not exposed to the pressure of the liquid.

9. The device of claim 8 wherein the downstream-most portion includes a spherically shaped portion, the valve seat and spherically shaped portion being so dimensioned that when the spherically shaped portion is against the valve seat, the spherically shaped portion is not exposed to the pressure of the liquid.

10. The device of claim 8 wherein the passageway includes a shoulder adjacent the valve seat, and the body further includes a reducer section downstream in the flow of the liquid through the device.

11. A system for dispensing coating material, the coating material dispensing system including a source of coating material to be dispensed, a device for dispensing the coating material, the coating material being provided from the source under pressure to the device, the device including a body having a passageway therethrough, a valve including a valve seat provided in the passageway and a valve member for engaging the valve seat to close the valve and moving away from the valve seat to open the valve, the valve seat and valve member being so dimensioned that when the valve member is against the valve seat, a portion of the valve member facing the valve seat is exposed to the pressurized coating material.

12. The system of claim 11 wherein the valve member includes a spherically shaped portion, the portion of the valve member facing the valve seat including the spherically shaped portion, the valve seat and spherically shaped portion being so dimensioned that when the spherically shaped portion is against the valve seat, a portion of the spherically shaped portion facing the valve seat is exposed to the liquid under pressure.

13. The system of claim 12 wherein the valve member further includes a surface further upstream from the valve seat than the spherically shaped portion in the direction of flow of the liquid, the surface generally facing the valve seat, the surface being exposed to the pressurized coating material.

14. The system of claim 11 wherein the passageway includes a shoulder adjacent the valve seat and the body further includes a reducer section downstream in the flow of the coating material through the device.

15. A system for dispensing coating material, the coating material dispensing system including a source of coating material to be dispensed, a device for dispensing the coating material, the coating material being provided from the source under pressure to the device, the device including a body having a passageway therethrough, a valve including a valve seat provided in the passageway and a valve member including a downstream-most portion for engaging the valve seat to close the valve and moving away from the valve seat to open the valve, the valve member further including a shoulder adjacent and upstream from the downstream-most portion in the direction of flow of the liquid through the device, the valve seat, downstream-most portion and shoulder being so dimensioned that the shoulder isolates the downstream-most portion from the liquid under pressure when the downstream-most portion is against the valve seat.

16. The system of claim 15 wherein the downstream-most portion includes a spherically shaped portion, the valve seat, spherically shaped portion and shoulder being so dimensioned that the shoulder isolates the spherically shaped portion from the liquid under pressure when the spherically shaped portion is against the valve seat.

17. The system of claim 15 wherein the passageway includes a shoulder adjacent the valve seat and the body further includes a reducer section downstream in the flow of coating material through the device.

18. A system for dispensing coating material, the coating material dispensing system including a source of coating material to be dispensed, a device for dispensing the coating material, the coating material being provided from the source under pressure to the device, the device including a body having a passageway therethrough, a valve including a valve seat provided in the passageway and a valve member including a downstream-most portion for engaging the valve seat to close the valve and moving away from the valve seat to open the valve, the valve seat and downstream-most portion being so dimensioned that when the downstream-most portion is against the valve seat, the downstream-most portion is not exposed to the pressurized coating material.

19. The system of claim 18 wherein the downstream-most portion includes a spherically shaped portion, the valve seat and spherically shaped portion being so dimensioned that when the spherically shaped portion is against the valve seat, the spherically shaped portion is not exposed to the pressurized coating material.

20. The system of claim 18 wherein the passageway includes a shoulder adjacent the valve seat, and the body further includes a reducer section downstream in the flow of the coating material through the device.
